(19) United States
(12) Patent Application Publication
(10) Pub. No.: US 2013/0224387 A1
(43) Pub. Date: Aug. 29, 2013

(54) DIRECT SMC PRODUCTION DEVICE

(71) Applicant: Matthias Feil, Ravensburg (DE)

(72) Inventor: Matthias Feil, Ravensburg (DE)

(73) Assignee: SCHMIDT & HEINZMANN GMBH & CO. KG, Bruchsal (DE)

(21) Appl. No.: 13/821,302

(22) PCT Filed: Sep. 15, 2011
(86) PCT No.: PCT/EP2011/004631

§ 371 Date: May 14, 2013

(30) Foreign Application Priority Data
Sep. 17, 2010 (DE) 10 2010 045 888.0

(51) Int. Cl. B05C 9/12

(52) U.S. Cl. CPC B05C 9/12
USPC 427/359; 118/123; 118/68; 118/36

(57) ABSTRACT

A direct SMC production device includes an impregnation device for impregnating fibers of a material strand. The impregnation device includes at least one densification unit which is designed to densify the material strand after application of the strand to at least one substrate.

### CROSS REFERENCE TO RELATED APPLICATIONS

This application is a U.S. national stage application of PCT/EP2011/004631 filed on Sep. 15, 2011, and claims priority to, and incorporates by reference, German patent application No. 10 2010 045 888.0 filed on Sep. 17, 2010.

### BACKGROUND

Direct SMC production devices having an impregnation device for impregnating fibers of a material strand are already known. The impregnation device in this case comprises an extrusion unit in which the material strand is densified and the fibers are impregnated. Subsequently, the material fiber strand is applied to a carrying element.

### SUMMARY

The invention is based on a direct SMC production device having an impregnation device for impregnating fibers of a material strand.

It is proposed that the impregnation device has at least one densification unit which is provided for the densification of the material strand after application of the latter onto at least one carrying element. In this context, the term “provided” is meant in particular to be understood as being specially equipped and/or specially designed. The term “direct SMC production device” is meant in this context in particular to be understood to be a device for the production of fiber-reinforced duroplastic materials, i.e. sheet molding compounds (SMC), which enables continuous production of mat-type molding materials with immediately subsequent further processing of the mat-type molding materials. The direct SMC production device is preferably connected to a production device for further processing, such as, for example, a press etc., by conveyor element, such as for instance conveyor belts, industrial robots etc. A mat-type molding material, in particular a resin mat, produced by the direct SMC production device according to the invention can thus be further processed directly and de-linked from any intermediate storage phase for curing, in particular one with a curing time of less than 6 hours.

The term “impregnation device” is meant in this context in particular to be understood to be a device which is provided to mix and/or soak fibers, in particular cut fibers, with at least one matrix material and/or to densify a material strand consisting of fibers and at least one matrix material. The term “material strand” is meant in this context in particular to define a sticky, cohesive molding material comprising fibers, in particular cut fibers, an at least one resin capable of cross-linking, and additives, such as for instance additives for shrinkage reduction, release agents, reactive agents, etc. The term “densification unit” is meant in this context in particular to be understood to be a unit which is specifically provided to reduce a volume, in particular by more than 5%, by means of applying a force to the material strand, and to increase a density, in particular a density of an arrangement of ingredients of the material strand in relation to one another, as compared with a volume and density prior to the application of force to the material strand. The term “carrying element” is meant in this context in particular to be understood to be a means that is specifically provided to accommodate individual components of the material strand and/or to protect a conveyor element, such as for instance a conveyor belt, from contamination and/or from adhesion of the material strand. The carrying element is preferably embodied as a carrier film. It is, however, also conceivable for the carrying element to be embodied as a carrier powder which can be applied to the conveyor element. By means of the embodiment according to the invention of the direct SMC production device, high densification of the material strand can be particularly advantageously achieved.

In a preferred embodiment of the direct SMC production device, the densification unit is formed by a rolling unit. The term “rolling unit” is meant in this context in particular to be understood to be a unit which has at least one component which moves, in particular rotates, about at least one axis and which, in at least one operating state, directly and/or indirectly rolls off on a material strand and densifies the material strand by means of the application of a force, in particular by means of the application of a force along a linear contact region between the component and the material strand. The rolling unit may have various components that appear expedient to a person skilled in the art, such as in particular at least one drum and/or particularly advantageously at least one roller. A densification device may be achieved by way of a simple design.

It is further proposed that the rolling unit has at least two adjustable rolling elements, in particular two rolling elements that are at least adjustable independently of one another. The term “rolling element” is meant in this context in particular to be understood to be a component, in particular a rotationally symmetric component, which is provided to remove media enclosed in a material strand, in particular air pockets, from the material strand by means of a rolling motion and to achieve intermixing, in particular homogeneity, within the material strand. The rolling elements are advantageously embodied as rollers and preferably have a cylindrical shape. The term “roller” is meant in this context in particular to be understood to be a component, the longitudinal extent of which along a rotation axis, with reference to a dimension, corresponds at least to an extent of a diameter, but preferably has at least a longitudinal extent which is double the size of an extent of a diameter. It is, however, also conceivable for the rolling elements to have another embodiment that appears expedient to a person skilled in the art. By means of an adjustable design of the rolling elements of the rolling unit, an application of force by the individual rolling elements on the material strand may be advantageously adjusted.

The impregnation device preferably has a control and/or regulation unit which is at least provided for adjusting the at least two rolling elements of the rolling unit in dependence on at least one production parameter. The term “production parameter” is meant in this context in particular to be understood to be a parameter which directly and/or indirectly influences a product made by the direct SMC production device, such as for instance the amount of a matrix material to be applied, a temperature of the material strand, etc. In this way, a particularly advantageous adjustment of the rolling elements to different production parameters may be achieved, thus enabling a high level of repetitive accuracy in manufacturing when using the direct SMC production device to be achieved.

It is further proposed that at least one rolling element of the rolling unit has a guide recess for guiding the material strand and/or a conveyor element. The term “guide means” is meant in this context in particular to be understood to be a recess which is specifically provided to guide the material strand in particular at least substantially perpendicularly to the direction of transport of the material strand. The guide recess is formed preferably by means of a reduction in a diameter of the rolling element embodied as a roller in a guide region of the rolling element, in comparison with a diameter of an adjoining region of the rolling element. The guide region merges with the adjacent region in a ramp-shaped fashion, such that an incline is created between the guide region and the adjacent region. It is, however, also conceivable for the transition from the guide region into the adjacent region to be stepped. The guide region is provided to accommodate the material strand and/or the conveyor element. Preferably, all the rolling elements have a guide recess. The term “conveyor element” is meant in this context in particular to be understood to be a means for transporting at least one produced product, in particular a material strand, in a predefined direction of production. Preferably, the conveyor element is embodied as a conveyor belt. An embodiment of the conveyor element as conveyor rollers is also conceivable. A uniform orientation of the conveyor element and/or the material strand may be advantageously achieved by the guide recess of the rolling element.

Advantageously, the densification unit comprises a main direction of extent which, in an operating state, is oriented at least substantially in the vertical direction. It is, however, also conceivable for the densification unit to have a main extent that extends in another direction that appears expedient to a person skilled in the art, such as for instance a horizontal direction. In this context, the term “in an operating state” in particular is meant to define a state of the direct SMC production device according to the invention, in which the direct SMC production device has been placed and installed in working order at a production site such that production with the direct SMC production device may take place and/or a state in which a production process is in progress. The term “at least substantially in the vertical direction” is meant in this case to be understood to be an orientation of the main direction of extent of the densification unit which is at least substantially perpendicular to the floor of the production site on which the machine feet of the direct SMC production device are arranged in an operating state. The term “substantially perpendicularly” is meant in this context in particular to define an orientation of a direction in relation to a reference direction, wherein the direction and the reference direction form an angle of 90° and the angle has a maximum deviation of in particular less than 8°, advantageously less than 5° and particularly advantageously less than 2°. A space-saving design of the direct SMC production device may be advantageously achieved.

It is further proposed that the direct SMC production device comprises a temperature setting unit which is at least provided for controlling the temperature of at least one conveyor element of the impregnation device. The temperature setting device is preferably embodied as a temperature regulation unit which heats a conveyor element to a predetermined temperature and in particular regulates a temperature of the conveyor element. In particular, the temperature setting unit heats the conveyor element to a temperature of greater than 20°, preferably greater than 30° and particularly preferably greater than 40°. By means of the temperature setting unit, the conveyor element may advantageously be heated to a temperature of the material strand, thus enabling advantageous further processing of the material strand.

The direct SMC production device advantageously comprises a cooling device at least for cooling the material strand, said cooling device being arranged downstream of the impregnation device, in particular downstream of the densification unit, in a direction of transport of the material strand. The term “cooling device” is meant in this context in particular to be understood to be a device which is specifically provided to achieve a temperature differential between at least two regions and/or between at least two components, in particular a temperature differential that is greater than 20° C. and preferably greater than 60° C. In particular, the cooling device is provided to cool at least one component to below an indoor temperature, in particular to below 20° C. and preferably below 10° C. Preferably, the cooling device comprises in this case a refrigeration unit. The material strand is preferably cooled by means of the cooling device to a temperature of approximately 0° C. to 2° C. It is, however, also conceivable for the material strand to be cooled to a temperature of less than 0° C. By means of the cooling device, the material strand may be cooled advantageously to a predetermined temperature for further processing. Moreover, a change in a viscosity of the material strand may be induced by the cooling device.

It is further proposed that the cooling device has at least one cooling plate element over which the material strand is conveyed in the direction of transport of the material. The term “cooling plate element” is meant in this context in particular to be understood to be an element that is embodied in the shape of a plate and through which at least partially a medium cooled by a refrigeration unit of the cooling device may circulate. Cooling of the material strand may be achieved by way of a simple design.

A further embodiment of the invention proposes that the cooling device has at least one cooling roller element which is at least partially wrapped by the material strand. The term “cooling roller element” is meant in this context in particular to be understood to be an element of cylindrical shape which rolls off on the material strand at least during a movement of the material strand in the direction of transport of the material strand and through which at least partially a medium cooled by a refrigeration unit of the cooling device may circulate. The material strand surrounds the cooling roller element preferably through a wrap angle of more than 120°. Preferably, a plurality of cooling roller elements are arranged in succession in the direction of transport of the material strand. A large cooling surface for cooling the material strand may advantageously be achieved.

Preferably, the direct SMC production device has at least one first fiber feeding device and one second fiber feeding device which are provided for feeding cut fibers to at least one carrying element. By means of an embodiment according to the invention, cut fibers may be fed to an ongoing production process by way of a simple design.

Advantageously, the first fiber feeding device is provided for feeding cut fibers to a first carrying element and advantageously, the second fiber feeding device is provided for feeding cut fibers to a second carrying element which, at least in an operating state, is formed separately from the first carrying element. Preferably, the first carrying element and the second carrying element are united in the impregnation device, in particular in the densification unit. Cut fibers may advantageously be fed to a first carrying element and a second carrying element independently of one another. Moreover, an advantageous distribution of cut fibers within the material strand may be achieved.

It is further proposed that the direct SMC production device comprises at least one first fiber cutting device, which is assigned to the first fiber feeding device, for cutting at least one continuous filament into cut fibers, and at least one second fiber cutting device, which is assigned to the second fiber feeding device, for cutting at least one continuous filament into cut fibers. The term “fiber cutting device” is meant in this context in particular to be understood to be a device which comprises at least one cutting element which is provided to cut and/or sever continuous filaments. Continuous filaments may advantageously be converted into cut fibers and fed directly to a production process.

Advantageously, the direct SMC production device comprises at least one continuous filament feeding device which is at least provided for feeding continuous filaments to a fiber cutting device by means of a fluid flow. The term “continuous filament feeding device” is meant in this context in particular to be understood to be a device which comprises at least one continuous filament entry and at least one transport unit for transporting the continuous filament to the fiber cutting device. The continuous filament feeding device is preferably formed by a compressed air feeding device. As a result, continuous filaments can be fed to the fiber cutting device by way of a simple design.

The invention is further based on a method for producing resin mats from fiber-reinforced polymer by means of a direct SMC production device.

It is proposed that a material strand is densified by means of a densification unit of an impregnation device after application of the strand onto at least one carrying element. Densification of the material strand may advantageously be achieved by way of a simple design.

### BRIEF DESCRIPTION OF THE DRAWINGS

Further advantages can be gathered from the following description of the drawing. The drawing illustrates an exemplary embodiment of the invention. The description and the claims include numerous features in combination. A person skilled in the art will expediently also consider the features individually and combine them in further meaningful combinations.

FIG. 1 is a view of a direct SMC production device according to the invention in a schematic illustration,

FIG. 2 is a detailed view of a continuous filament feeding device of the direct SMC production device according to the invention in a schematic illustration,

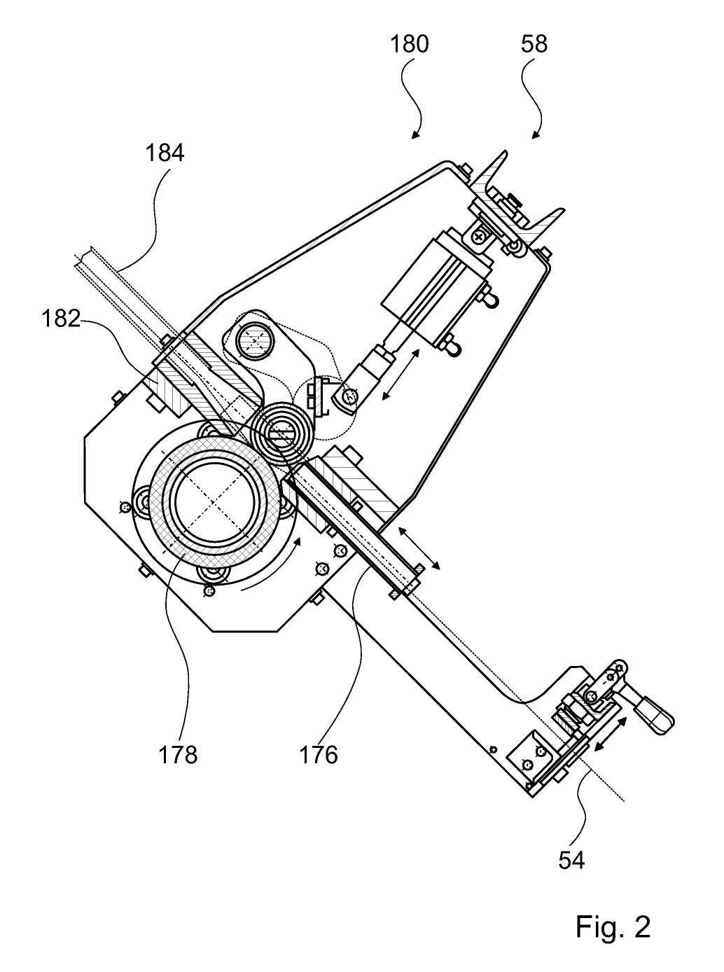

FIG. 3 is a detailed view of a rolling element of a rolling unit of the direct SMC production device according to the invention in a schematic illustration, and

FIG. 4 is a detailed view of a cooling device of the direct SMC production device according to the invention in a schematic illustration.

### DETAILED DESCRIPTION

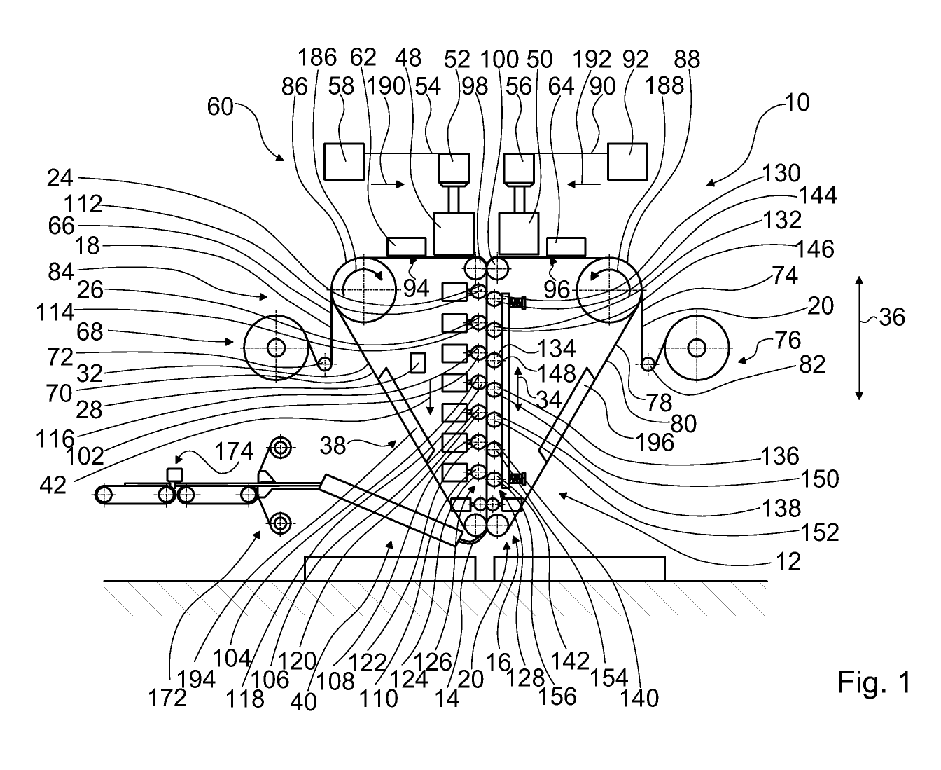

FIG. 1 shows a direct SMC production device 10 which comprises an impregnation device 12 for impregnating fibers of a material strand 14. The fibers are embodied as cut fibers. The direct SMC production device 10 has a pump unit (not illustrated here) which is provided to feed a resin paste to a material application unit 60. The resin paste, in this instance, may consist for example of a polyester resin, a vinyl ester resin or any other resin which appears expedient to a person skilled in the art, and which is mixed with additives. The pump unit comprises a gear-type pump (not illustrated here) which generates a constant fluid flow. It is, however, also conceivable for the pump unit to comprise another type of pump which appears expedient to a person skilled in the art, for example a piston-type pump etc.

The material application unit 60 comprises a first doctor box 62 and a second doctor box 64. The first doctor box 62 is assigned to a first carrying element 18. The first carrying element 18 is formed by a first carrier film 66 which is fed by means of a first film unwinding device 68 of the direct SMC production device to a conveyor element 32, embodied as a conveyor belt 70, of the impregnation device 12. The first film unwinding device 68 further comprises a brush roller 72 which is provided to smooth the first carrier film 66 prior to its being placed on the conveyor belt 70. The second doctor box 64 is assigned to a second carrying element 20. The second carrying element 20 is formed by a second carrier film 74 which is fed by means of a second film unwinding device 76 of the direct SMC production device 10 to a conveyor element 80, embodied as a further conveyor belt 78, of the impregnation device 12. The second film unwinding device 76 likewise comprises a brush roller 82 which is provided to smooth the second carrier film 74 prior to its being placed on the further conveyor belt 78.

The impregnation device 12 further comprises a conveyor belt drive unit 84 which is provided to drive a first drive roller 86 for driving the conveyor belt 70 and a second drive roller 88 for driving the further conveyor belt 78. The first drive roller 86 and the second drive roller 88 are driven synchronously with one another, thus enabling synchronous running to be achieved between the conveyor belt 70 and the further conveyor belt 78 in a direction of transport 42 of the material strand. The drive rollers 86, 88 are driven in opposite directions of rotation 186, 188 to one another. Moreover, the drive rollers 86, 88 have a diameter of approximately 250 mm to 300 mm.

The first doctor box 62 and the second doctor box 64 are filled with a resin paste (not illustrated here) by means of the pump unit. An optical sensor unit (not illustrated here) on the material application unit 60 senses the filling quantity of the first doctor box 62 and of the second doctor box 64. A control and/or regulation unit (not illustrated here) of the material application unit 60 monitors the filling quantity of the first doctor box 62 and of the second doctor box 64 and thus controls the pump unit. By means of a heating unit (not illustrated here) of the material application unit 60, a viscosity of the resin paste can be set. Moreover, the material application unit 60 comprises a drive unit (not illustrated here) which is provided to move the first doctor box 62 and the second doctor box 64 in relation to the carrier films 66, 74, thus enabling a gap between the first doctor box 64 and the first carrier film 66 and a gap between the second doctor box 64 and the second carrier film 74 to be set. As a result, the application amount of resin paste onto the carrier films 66, 74 is predetermined.

Furthermore, the direct SMC production device 10 comprises a first fiber feeding device 48 and a second fiber feeding device 50 which are provided for feeding cut fibers to at least one carrying element 18, 20 embodied as carrier film 66, 74. The first fiber feeding device 48 is provided for feeding cut fibers to the carrying element 18 embodied as a carrier film 66, and the second fiber feeding device 50 is provided for feeding fibers to the second carrying element 20 embodied as carrier film 74, which, in an operating state, is formed separately from the first carrying element 18. The first fiber feeding device 48 is arranged downstream of the first doctor box 62 in a conveying direction 190 of the conveyor belt 70 in a horizontally extending subregion 94 of the conveyor belt 70 and at a spacing from the carrier film 66 perpendicularly to the conveying direction 190. The second fiber feeding device 50 is arranged downstream of the second doctor box 64 in a conveying direction 192 of the second conveyor belt 78 in a horizontally extending subregion 96 of the further conveyor belt 78 and at a spacing from the carrier film 74 perpendicularly to the conveying direction 192. Cut fibers are fed by means of the first fiber feeding device 48 to the resin paste already applied onto the first carrier film 66 by the first doctor box 62.

Moreover, cut fibers are fed by means of the second fiber feeding device 50 to the resin paste already applied onto the second carrier film 74 by the second doctor box 64. Thus, after cut fibers have been fed, a material strand 14 consisting of cut fibers and resin paste is arranged on each of the first carrier film 66 and the second carrier film 74.

The direct SMC production device 10 further comprises a first fiber cutting device 52, which is assigned to the first fiber feeding device 48, for cutting at least one continuous filament 54 into cut fibers, and at least one second fiber cutting device 56, which is assigned to the second fiber feeding device 50, for cutting an at least one continuous filament 90 into cut fibers. The continuous filaments 54, 90 are fed by continuous filament feeding devices 58, 92 of the direct SMC production device 10 to the first fiber cutting device 52 and the second fiber cutting device 56 by means of a fluid flow. In this case, one of the continuous filament feeding devices 58, 92 is assigned to the first fiber cutting device 52, and one of the continuous filament feeding devices 58, 92 is assigned to the second fiber cutting device 56.

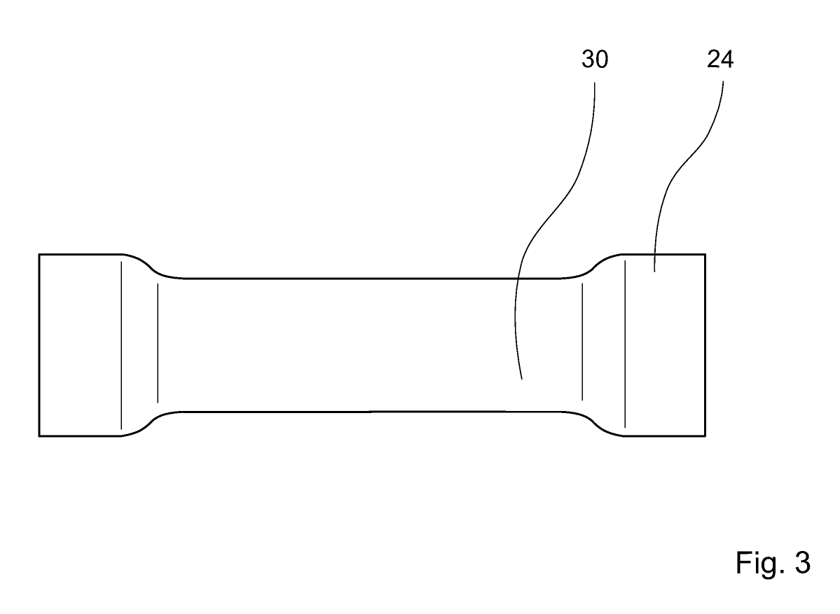

The continuous filament feeding device 58, which is assigned to the first fiber cutting device 52, is shown in more detail in FIG. 3. The continuous filament feeding device 58 has an injection tube 176, by means of which a continuous filament 54 is introduced into the continuous filament feeding device 58. Moreover, the continuous filament feeding device 58 has a thread draw roller 178, which, together with a pressing unit 180 of the continuous filament feeding device 58, transfers the continuous filament 54 to a continuous filament take-up 182. The continuous filament take-up 182 is connected to the first fiber cutting device 52 by way of a tube 184. The continuous filament 54 is transported through the tube 184 to the first fiber cutting device 52 by means of compressed air. The continuous filament feeding device 92, which is assigned to the second fiber cutting device 56, has an analogous design, and so reference is made here to the aforementioned description.

The first fiber cutting device 52, the first fiber feeding device 48 and the first doctor box 62 are located in the horizontally extending subregion 94 of the conveyor belt 70 of the impregnation device 12. The second fiber cutting device 56, the second fiber feeding device 50 and the second doctor box 64 are located in the likewise horizontally extending subregion 96 of the further conveyor belt 78 of the impregnation device 12.

The direct SMC production device 10 further has a temperature setting unit 38 which is provided for controlling the temperature of at least one conveyor element 32, 80 of the impregnation device 12. The temperature setting unit 38 is provided for adjusting a temperature of the conveyor belt 70 and a temperature of the further conveyor belt 78 of the impregnation device 12 to a temperature of the applied resin paste. To this end, the temperature setting unit 38 comprises a first heating unit 194 which is assigned to the conveyor belt 70, and a second heating unit 196 which is assigned to the further conveyor belt 78.

The impregnation device 12 further comprises a densification unit 16 which is provided for the densification of the material strand 14 after application of the resin paste and the cut fibers of the material strand 14 to the first carrying element 18 and the second carrying element 20. The densification unit 16 has a main direction of extent 34 which, in an operating state, is oriented at least substantially in a vertical direction 36. Thus, the main direction of extent 34 of the densification unit 16 is arranged at least substantially perpendicularly to the horizontally extending subregions 94, 96 of the conveyor belt 70 and the further conveyor belt 78. The conveyor belt 70 and the further conveyor belt 78 are deflected in the region of the densification unit 16 in the direction of the main direction of extent 34 of the densification unit 16 in each case by means of a deflection roller 98, 100 of the impregnation device 12. The deflection rollers 98, 100 have a diameter of approximately 120 mm. During the deflection of the conveyor belt 70 and the further conveyor belt 78, the resin paste and the cut fibers on the first carrier film 66 and the resin paste and the cut fibers on the second carrier film 74 are united. Thus, a joint material strand 14 is formed and is conveyed through the densification unit 16.

The densification unit 16 is formed by a rolling unit 22. Temperature control of the rolling unit 22 by means of the temperature setting unit 38 is likewise conceivable. The rolling unit 22 has at least two adjustable rolling elements 24, 26. In total, the rolling unit 22 comprises seven adjustable rolling elements 24, 26, 102, 104, 106, 108, 110 which are adjustable in relation to one another. The rolling elements 24, 26, 102, 104, 106, 108, 110 are embodied as rollers 112, 114, 116, 118, 120, 122, 124. The rolling elements 24, 26, 102, 104, 106, 108, 110 of the rolling unit 22 that are embodied as rollers 112, 114, 116, 118, 120, 122, 124 each have a guide recess 30 (FIG. 3) for guiding the material strand 14 and/or the guide means 32 embodied as conveyor belt 70.

Moreover, the impregnation device 12 has a control and/or regulation unit 28 which is provided for adjusting the rolling elements 24, 26, 102, 104, 106, 108, 110 of the rolling unit 22 that are embodied as rollers 112, 114, 116, 118, 120, 122, 124 in dependence on at least one production parameter. The rollers 112, 114, 116, 118, 120, 122, 124 may in this case be adjusted by a pneumatic unit (not illustrated here) by means of compressed air in a direction perpendicular to the main direction of extent 34 of the densification unit 16. It is, however, also conceivable for the rollers 112, 114, 116, 118, 120, 122, 124 to be hydraulically or electrically adjustable. As a result, a pressure for the purpose of densification may be applied to the material strand 14.

The rollers 112, 114, 116, 118, 120, 122, 124 are arranged within the rolling unit 22 in succession in the direction of transport 42 of the material strand in a first bank of rollers 126 of the rolling unit 22. The rolling unit 22 further has a second bank of rollers 128 which extends at least substantially parallel to the direction of transport 42 of the material strand and to the first bank of rollers 126. Furthermore, the first bank of rollers 126 and the second bank of rollers 128 are arranged at a spacing from one another perpendicularly to the direction of transport 42 of the material strand. The second bank of rollers 128 likewise has seven rolling elements 144, 146, 148, 150, 152, 154, 156 embodied as rollers 130, 132, 134, 136, 138, 140, 142. The rollers 130, 132, 134, 136, 138, 140, 142 are spring-mounted as a unit and designed to be adjustable in the direction of transport 42 of the material strand. Furthermore, the unit comprising the rollers 130, 132, 134, 136, 138, 140, 142 of the second bank of rollers 128 may be moved perpendicularly to the main direction of extent 34 of the densification unit 16, such that easy access to the first bank of rollers 126 and the second bank of rollers 128 can be enabled for starting up or for fault recovery. The latter likewise have a guide recess which is embodied in an analogous manner to the guide recess 30 of the rollers 112, 114, 116, 118, 120, 122, 124 of the first bank of rollers 126, and so reference may be made to FIG. 3 for the description of an embodiment of the guide recess in the rollers 130, 132, 134, 136, 138, 140, 142 of the second bank of rollers 128.

The rollers 112, 114, 116, 118, 120, 122, 124 of the first bank of rollers 126 rotate in an operating state in an opposite direction to the rollers 130, 132, 134, 136, 138, 140, 142 of the second bank of rollers 128. Furthermore, the rollers 112, 114, 116, 118, 120, 122, 124 of the first bank of rollers 126 are arranged offset in the direction of transport 42 of the material strand in relation to the rollers 130, 132, 134, 136, 138, 140, 142 of the second bank of rollers 128. Rotation axes of the rollers 112, 114, 116, 118, 120, 122, 124 of the first bank of rollers 126 are arranged offset in the direction of transport of the material strand 42 approximately by an extent of a radius of the rollers 112, 114, 116, 118, 120, 122, 124 in relation to rotation axes of the rollers 130 132, 134, 136, 138, 140, 142 of the second bank of rollers 128. In this case, the rollers 112, 114, 116, 118, 120, 122, 124 of the first bank of rollers 126 and the rollers 130, 132, 134, 136, 138, 140, 142 of the second bank of rollers 128 have the same radius. The conveyor belt 70 and the further conveyor belt 78 of the impregnation device 12 and the material strand 14 located in between, and the first carrier film 66 and the second carrier film 74 are guided in the direction of transport 42 of the material strand between the first bank of rollers 126 and the second bank of rollers 128. In this case, the material strand 14 is densified and the cut fibers of the material strand 14 are impregnated.

The direct SMC production device 10 further has a cooling device 40 for cooling the material strand 14, said cooling device 40 being arranged downstream of the impregnation device 12 in the direction of transport 42 of the material strand. The material strand 14 and the first carrier film 66 and the second carrier film 74 are fed to the cooling device 40 after leaving the rolling unit 22. The cooling device completely surrounds the material strand 14 in a plane perpendicular to the direction of transport 42 of the material strand.

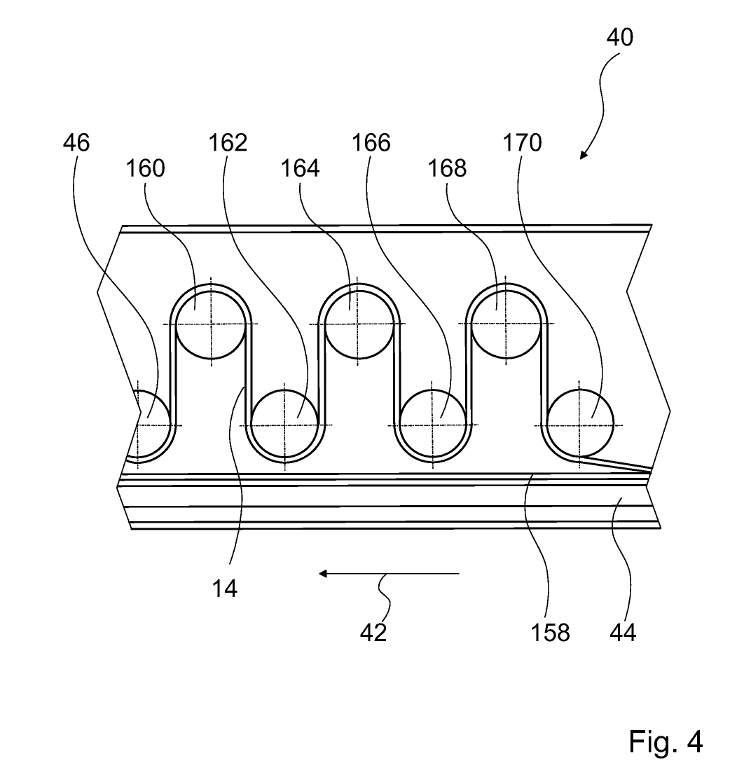

Furthermore, the cooling device 40 has a cooling plate element 44 over which the material strand 14 is conveyed in the direction of transport 42 of the material strand (FIG. 4). The cooling plate element 44 is located beneath a conveyor belt 158 which conveys the material strand 14 in the direction of transport 42 of the material strand within the cooling device 40. It is, however, also conceivable for the cooling device 40 to have further cooling plate elements 44, such that the material strand 14, when viewed in a plane perpendicular to the direction of transport 42 of the material strand, is completely surrounded by cooling plate elements 44.

Furthermore, the cooling device 40 has at least one cooling roller element 46 which is at least partially wrapped by the material strand 14 (FIG. 4). In total, the cooling device 40 has a plurality of cooling roller elements 46, 160, 162, 164, 166, 168, 170, of which only seven cooling roller elements 46, 160, 162, 164, 166, 168, 170 are illustrated in FIG. 4. The material strand 14 surrounds the cooling roller elements 46, 160, 162, 164, 166, 168, which are arranged in a passage region of a set of cooling rollers of the cooling device 40, through a wrap angle of more than 160°. The cooling roller elements 170, which are arranged in an entry region or an exit region, respectively, of the set of cooling rollers, are surrounded by the material strand 14 through a wrap angle of approximately 80°. The cooling plate element 44 is arranged beneath the cooling roller elements 46, 160, 162, 164, 166, 168, 170, when viewed in an operating state. Alternatively, it is also conceivable for the cooling device 40 to comprise merely the cooling plate element 44 or merely the cooling roller elements 46, 160, 162, 164, 166, 168, 170 for cooling the material strand 14.

In the cooling device 40, the material strand 14 is conveyed over of the cooling plate element 44 by means of the conveyor belt 158 within the cooling device 40. Thereafter, the material strand 14 is conveyed through the cooling roller elements 46, 160, 162, 164, 166, 168, 170. After the material strand 14 has passed through the set of cooling rollers consisting of the cooling roller elements 46, 160, 162, 164, 166, 168, 170, the material strand 14 is conveyed out of the cooling device 40. Within the cooling device 40, the material strand 14 is cooled to a temperature of approximately 0° C. to 2° C.

After the material strand 14 has left the cooling device 40, the material strand 14, together with the first carrier film 66 and the second carrier film 74, is fed to a film winding-up device 172. The film winding-up device 172 is provided for separating the first carrier film 66 and the second carrier film 74 from the material strand 14, and for winding up the first carrier film 66 and the second carrier film 74 in each case separately from one another. The material strand 14 is subsequently fed to a cutting device 174 which detaches pieces from the material strand 14 for subsequent further processing, for instance by means of a press.

1. A direct SMC production device having an impregnation device (12) for impregnating fibers of a material strand (14), characterized in that the impregnation device (12) has at least one densification unit (16) which is provided for the densification of the material strand (14) after application of the latter onto at least one carrying element (18, 20).

2. The direct SMC production device as claimed in claim 1, characterized in that the densification unit (16) is formed by a rolling unit (22).

3. The direct SMC production device as claimed in claim 2, characterized in that the rolling unit (22) has at least two adjustable rolling elements (24, 26, 102, 104, 106, 108, 110).

4. The direct SMC production device as claimed in claim 3, characterized in that the impregnation device (12) has a control and/or regulation unit (28) which is at least provided for adjusting the at least two rolling elements (24, 26, 102, 104, 106, 108, 110) of the rolling unit (22) in dependence on at least one production parameter.

5. The direct SMC production device as claimed in at least claim 2, characterized in that at least one rolling element (24, 26, 102, 104, 106, 108, 110, 144, 146, 148, 150, 152, 154, 156) of the rolling unit (22) has a guide recess (30) for guiding the material strand (14) and/or a conveyor element (32, 80).

6. The direct SMC production device as claimed in one of the preceding claims, characterized in that the densification unit (16) comprises a main direction of extent (34) which, in an operating state, is oriented at least substantially in the vertical direction (36).

7. The direct SMC production device as claimed in one of the preceding claims, characterized by a temperature setting unit (38) which is at least provided for controlling the temperature of at least one Conveyor element (32, 80) of the impregnation device (12).

8. The direct SMC production device as claimed in one of the preceding claims, characterized by a cooling device (40) at least for cooling the material strand (14), said cooling device (40) being arranged downstream of the impregnation device (12) in a direction of transport (42) of the material strand (14).

9. The direct SMC production device as claimed in claim 8, characterized in that the cooling device (40) has at least one cooling plate element (44) over which the material strand (14) is conveyed in the direction of transport (42) of the material strand (14).

10. The direct SMC production device as claimed in at least claim 8, characterized in that the cooling device (40) has at least one cooling roller element (46, 160, 162, 164, 166, 168, 170) which is at least partially wrapped by the material strand (14).

11. The direct SMC production device as claimed in one of the preceding claims, characterized by at least one first fiber feeding device (48) and one second fiber feeding device (50) which are provided for feeding cut fibers to at least one carrying element (18, 20).

12. The direct SMC production device as claimed in at least claim 10, characterized in that the first fiber feeding device (48) is provided for feeding cut fibers to a first carrying element (18) and the second fiber feeding device (50) is provided for feeding cut fibers to a second carrying element (20) which, at least in an operating state, is formed separately from the first carrying element (18).

13. The direct SMC production device as claimed in at least claim 10 or 11, characterized by at least one first fiber cutting device (52), which is assigned to the first fiber feeding device (48), for cutting at least one continuous filament (54) into cut fibers, and at least one second fiber cutting device (56), which is assigned to the second fiber feeding device (50), for cutting at least one continuous filament (90) into cut fibers.

14. The direct SMC production device as claimed in one of the preceding claims, characterized by at least one continuous filament feeding device (58, 92) which is at least provided for feeding continuous filaments (54, 90) to a fiber cutting device (52, 56) by means of a fluid flow.

15. A method for producing resin mats made from fiber-reinforced polymer, in particular by means of a direct SMC production device (10) as claimed in one of the preceding claims, characterized in that a material strand (14) is densified by a densification unit (16) of an impregnation device (12) after application of the strand onto at least one carrying element (18, 20).
